(19) United States
(12) Patent Application Publication
(10) Pub. No.: US 2002/0009989 A1
(43) Pub. Date: Jan. 24, 2002

(54) Method and system for providing service information through mobile communication device, mobile communication device, portable terminal, mobile communication management server, and computer-readable recording medium

(76) Inventors: Toshiya Kanesaka, Chiba-shi (JP); Koichi Moriya, Chiba-shi (JP); Akira Sugiyama, Chiba-shi (JP); Jun Hirotomi, Chiba-shi (JP); Kazuhiro Koyama, Chiba-shi (JP); Toshiyuki Fujiwara, Chiba-shi (JP); Kaori Takano, Chiba-shi (JP)

Correspondence Address: ADAMS & WILKS, ATTORNEYS AND COUNSELORS AT LAW, 31st Floor, 50 Broadway, New York, NY, 10004, US

(21) Appl. No.: 09/903,598

(22) Filed: Jul. 12, 2001

(30) Foreign Application Priority Data
Jul. 24, 2000 (JP) 2000-222792

(51) Int. Cl. H04M 3/00

(52) U.S. Cl. 455/414; 455/418; 455/419

(57) ABSTRACT

An information provision method effectively utilizes a mobile communication infrastructure to offer a user-friendly communication service. A portable telephone is carried in a state of being separated from a user's body while a wrist-worn portable terminal is carried in a state of being maintained in direct contact with the user's wrist like a wristwatch. When the portable telephone receives service information during a main communication process, e.g., telephone conversation, it transfers the service information to the wrist-worn portable terminal. The wrist-worn portable terminal outputs and displays the transferred service information. A portable telephone company enables communication through the user's portable telephone by using a portable telephone communication infrastructure, and transmits service information to the portable telephone during intervals between time periods for the main communication process. A service information provider company provides an advertisement as service information to be transmitted to the user's portable telephone.

### BACKGROUND OF THE INVENTION

1. Field of the Invention

The present invention relates to a method and system for providing service information through a mobile communication device, a mobile communication device, a portable terminal, a mobile communication management server, and a computerreadable recording medium. The present invention is particularly useful in improving customer service to users who use mobile communication devices such as portable telephones or terminals in the Personal Handyphone System (PHS) as well as in providing a new business.

2. Description of the Related Art

Techniques for performing communication based on a cellular system or a code division multiple access (CDMA) system, i.e., communication using mobile devices, such as portable telephones or PHS terminals in the PHS system, have recently been developed. Also, techniques enabling easier use of such devices have been provided.

However, this kind of mobile communication techniques are under development and the development cost is reflected in the telephone rate, so that users must pay high telephone rates. Thus, the improvement in communication service in terms of user's satisfaction has been limited. On the other hand, with the development of communication techniques, communication systems have been developed in which mobile communication devices such as portable telephones can transmit and receive character and image data as well as phone conversation signals.

### SUMMARY OF THE INVENTION

In view of the above-described circumstances, an object of the present invention is to provide means for offering more user-friendly communication service by effectively utilizing mobile communication infrastructures.

To achieve this object, according to one aspect of the present invention, there is provided a method of providing service information through a mobile communication device, characterized by comprising the steps of accumulating service information to be transmitted to mobile communication devices, transmitting service information to arbitrary one of the mobile communication devices during intervals between time periods for a main communication process performed by the arbitrary one of the mobile communication devices, and outputting the service information on the mobile communication device side. According to this method, while a user is mainly performing communication such as telephone conversation or mailing by using a portable telephone, service information is provided in association with the main communication. Thus, this method improves customer service and enables provision of a new operation.

The above-mentioned service information is some of various kinds of information, e.g., an advertisement, a quiz, a questionnaire, a prize competition, and information from a portable telephone company. The mobile communication device is, for example, a portable telephone, a PHS terminal, or a personal data assistant (PDA).

The above-described method of providing service information through the mobile communication device in accordance with the present invention characterized by also comprising the step of transferring the service information from the mobile communication device receiving the service information to a portable terminal capable of direct communication with the mobile communication device, the service information being output by the portable terminal. In a case where a user cannot see the display of the mobile communication device when using the mobile communication device for telephone conversation, the service information can be output by being displayed on the portable terminal, thereby enabling the user to recognize the information.

The above-described method of providing service information through the mobile communication device in accordance with the present invention characterized by also comprise the step of requesting the user to confirm the user's intention to output the service information or not. This step enables the user to output the service information or inhibit outputting of the service information according to user's wish. Thus, service information can be provided according to circumstances under which the user is using the mobile communication device.

The above-described method of providing service information through the mobile communication device in accordance with the present invention characterized by comprising the step of requesting the user to confirm the user's intention to output the service information or not, and outputting the service information by determining that the user has performed a predetermined confirmation operation when an acceleration sensor provided in the portable terminal detects a predetermined acceleration. For example, if the portable terminal is of a wristwatch type (hereinafter referred to as “wrist-worn portable terminal), and if the user makes, for example, a rotational motion of the arm, this motion can be detected as an acceleration. In this manner, the user can easily perform the confirmation operation.

The above-described method of providing service information through the mobile communication device in accordance with the present invention characterized by comprising the step of transmitting the service information to the mobile communication device and making the mobile communication device output the service information in a predetermined cycle during the main communication process, thus enabling the service information provider to efficiently to carry out the operation.

The above-described method of providing service information through the mobile communication device in accordance with the present invention may also comprise the step of computing an amount claimed to be paid for communication such that the charge for communication to be paid by the user using the service information during the main communication process is reduced to zero while the service information provider is charged the amount corresponding to the charge for communication, thus making it possible to provide a service beneficial to users.

The above-described method of providing service information through the mobile communication device in accordance with the present invention may comprise the step of computing an amount claimed to be paid for communication such that the charge for communication to be paid by the user using the service information during the main communication process is discounted while the service information provider is charged the amount corresponding to the reduction in the charge for communication to be paid by the user, thus making it possible to provide a service beneficial to users.

The above-described method of providing service information through a mobile communication device in accordance with the present invention may comprise the step of adding a point for offering a privilege to the user according to the service information used by the user during the main communication process, thus making it possible to provide a service beneficial to users.

The above-described method of providing service information through a mobile communication device in accordance with the present invention may comprise the step of transmitting the service information as letter or image information to the mobile communication device and making the mobile communication device display the information if the main communication process is a process of telephone communication using speech, thus providing service information by considering user's operating ease.

The above-described method of providing service information through a mobile communication device in accordance with the present invention may comprise the step of transmitting the service information as speech information to the mobile communication device and making the mobile communication device announce the information if the main communication process is a process of communication using letters or an image, thus providing service information by considering user's operating ease.

According to another aspect of the present invention, there is provided a system for providing service information through a mobile communication device, comprising service information accumulation means for accumulating service information to be transmitted to mobile communication devices, service information transmitting means for transmitting the service information to arbitrary one of the mobile communication devices during intervals between time periods for a main communication process performed by the arbitrary one of the mobile communication devices, and service information outputting means for outputting the service information on the mobile communication device side, thereby enabling the above-described method for providing service information through the mobile communication device to be carried out.

The above-described system for providing service information through the mobile communication device may also comprise service information transfer means for transferring the service information from the mobile communication device receiving the service information to a portable terminal capable of direct communication with the mobile communication device. The service information transfer means is provided in the portable terminal, and the portable terminal outputs the service information, thereby enabling the above-described method for providing service information through the mobile communication device to be carried out.

The above-described system for providing service information through the mobile communication device may comprise confirmation means for requesting a user to confirm the user's intention to output the service information or not, thereby enabling the above-described method for providing service information through the mobile communication device to be carried out.

The above-described system for providing service information through the mobile communication device may comprise confirmation means for requesting a user to confirm the user's intention to output the service information or not, and an acceleration sensor provided in the portable terminal. When a predetermined acceleration is detected by the acceleration sensor, the confirmation means determines that the user has performed a predetermined confirmation operation, and enables outputting of the service information, thereby enabling the above-described method for providing service information through the mobile communication device to be carried out.

The above-described system for providing service information through the mobile communication device may comprise timing output means for transmitting the service information to the mobile communication device and making the mobile communication device output the service information in a predetermined cycle during the main communication process, thereby enabling the above-described method for providing service information through the mobile communication device to be carried out.

The above-described system for providing service information through the mobile communication device may also comprise free-of-charge communication fee computation means for computing an amount claimed to be paid for communication such that the charge for communication to be paid by the user using the service information during the main communication process is reduced to zero while the service information provider is charged the amount corresponding to the charge for communication, thereby enabling the above-described method for providing service information through the mobile communication device to be carried out.

The above-described system for providing service information through the mobile communication device may comprise discounted communication fee computation means for computing an amount claimed to be paid for communication such that the charge for communication to be paid by the user using the service information during the main communication process is discounted while the service information provider is charged the amount corresponding to the reduction in the charge for communication to be paid by the user, thereby enabling the above-described method for providing service information through the mobile communication device to be carried out.

The above-described system for providing service information through the mobile communication device may comprise point addition means for adding a point for offering a privilege to the user according to the service information used by the user during the main communication process, thereby enabling the above-described method for providing service information through the mobile communication device to be carried out.

The above-described system for providing service information through the mobile communication device may comprise letter and image selection means for transmitting the service information as letter or image information to the mobile communication device and making the mobile communication device display the information if the main communication process is a process of telephone communication using speech, thereby enabling the above-described method for providing service information through the mobile communication device to be carried out.

The above-described system for providing service information through the mobile communication device may comprise announcement selecting means for transmitting the service information as speech information to the mobile communication device and making the mobile communication device announce the information if the main communication process is a process of communication using letters or an image, thereby enabling the above-described method for providing service information through the mobile communication device to be carried out.

According to still another aspect of the present invention, there is provided a mobile communication device comprising service information transfer means for transferring service information to a portable terminal capable of direct communication with the mobile communication device when the mobile communication device receives the service information.

According to yet still another aspect of the present invention, there is provided a portable terminal comprising service information output means for outputting service information when the service information is transferred from a mobile communication device capable of direct communication with the portable terminal.

The portable terminal in accordance with the present invention may comprise confirming means for requesting a user to confirm the user's intention to output the service information or not in the above portable terminal.

The portable terminal in accordance with the present invention may comprise an acceleration sensor. When a predetermined acceleration is detected by the acceleration sensor, the confirmation means determines that the user has performed a predetermined confirmation operation, and enables outputting of the service information.

According to a further aspect of the present invention, there is provided a mobile communication management server comprising service information transmitting means for transmitting service information to an arbitrary mobile communication device during intervals between time periods for a main communication process when the main communication is performed by an arbitrary mobile communication device.

The mobile communication management server in accordance with the present invention may also comprise service information accumulation means for accumulating service information to be transmitted to the mobile communication devices.

The mobile communication management server in accordance with the present invention may also comprise service information acquisition means connected to a provider server which is managed by a service information provider, and in which service information to be transmitted to the mobile communication devices is accumulated. The service information acquisition means obtains service information from the server and transmits the service information to the above-mentioned mobile communication device.

According to still a further aspect of the present invention, there is provided a computer-readable recording medium comprising a program stored thereon, the program enabling a computer to execute the above-described method of providing service information through the mobile communication device mentioned in the above invention. Further, there is also provided a computer-readable recording medium comprising a program recorded thereon so as to be readable by a computer, the program realizing each of the above-described means.

### BRIEF DESCRIPTION OF THE DRAWINGS

A preferred form of the present invention is illustrated in the accompanying drawings in which:

FIG. 1 is a schematic diagram for explaining a method of providing a service information through a portable telephone in accordance with the present invention;

FIG. 2 is a diagram showing the configuration of a network representing a system for providing a service information through the portable telephone in Embodiment 1 of the present invention;

FIG. 3 is a diagram showing the hardware configuration of the portable telephone in accordance with the present invention;

FIG. 4 is a diagram showing the hardware configuration of a wrist-worn portable terminal in accordance with the present invention;

FIG. 5 is a diagram showing the hardware configuration of a portable telephone company server in accordance with the present invention;

FIG. 6 is a diagram showing the configuration of functional components of the service information provision system in Embodiment 1 of the present invention;

FIG. 7 is a communication sequence diagram of Embodiment 1 of the present invention;

FIG. 8 is a flowchart showing a process performed by the wrist-worn portable terminal in Embodiment 1 of the present invention;

FIG. 9 is a flowchart showing confirmation operations in the portable telephone company server in Embodiment 1 of the present invention;

FIG. 10 is a flowchart showing another process performed by the wrist-worn portable terminal in Embodiment 1 of the present invention;

FIG. 11 is a communication sequence diagram of Embodiment 2 of the present invention;

FIG. 12 is a diagram showing the configuration of a network representing a system for providing a service information through the portable telephone in Embodiment 3 of the present invention;

FIG. 13 is a diagram showing the hardware configuration of an advertisement provider company server in accordance with the present invention;

FIG. 14 is a diagram showing the configuration of functional components of the service information provision system in Embodiment 3 of the present invention; and

FIG. 15 is a communication sequence diagram of Embodiment 3 of the present invention.

### DESCRIPTION OF THE PREFERRED EMBODIMENTS

Embodiments of the present invention will be described in detail with reference to the accompanying drawings. The embodiments described below are for illustrative purposes only and are not intended to limit the scope of the invention.

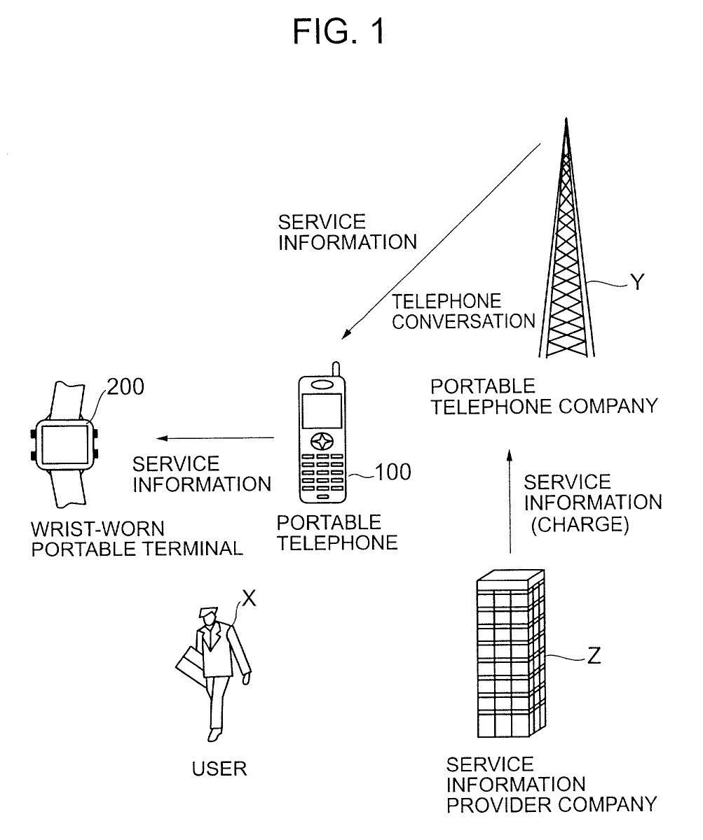

FIG. 1 shows a diagram for explaining a method of providing service information through a portable telephone. As shown in FIG. 1, a user X has a portable telephone 100 and a wrist-worn portable terminal 200. For example, the portable telephone 100 is put in a briefcase or the like and carried in a state of being separated from the user's body while the wrist-worn portable terminal 200 is carried in a state of being maintained in direct contact on the user X's wrist like a wristwatch. When the portable telephone 100 receives service information during a main communication process, e.g., telephone conversation or transmitting or receiving mail, it transfers the service information to the wrist-worn portable terminal 200. The wrist-worn portable terminal 200 outputs the transferred service information in the form of a visual display or speech.

A portable telephone company Y uses a communication infrastructure to enable communication using the portable telephone 100 in the user X's possession. The portable telephone company Y transmits service information to the portable telephone 100 during intervals between time periods for a main communication process, e.g., telephone conversation or mailing performed by the portable telephone as a duty of a service information providing method of a portable telephone of this invention. A service information provider company Z, which is, for example, an advertising agency, provides an advertisement as service information to be transmitted to the portable telephone 100 in the user X's possession.

In the embodiments described below, the above-described service information is an advertisement and an example in the case the mobile communication device is a portable telephone is described. The processing of the present invention can be performed in the same manner even in a case where the service information is a questionnaire or a quiz or a mobile communication device such as a PHS in the above-mentioned other kinds of information. Therefore only the cases of the embodiments will be described.

Embodiment 1

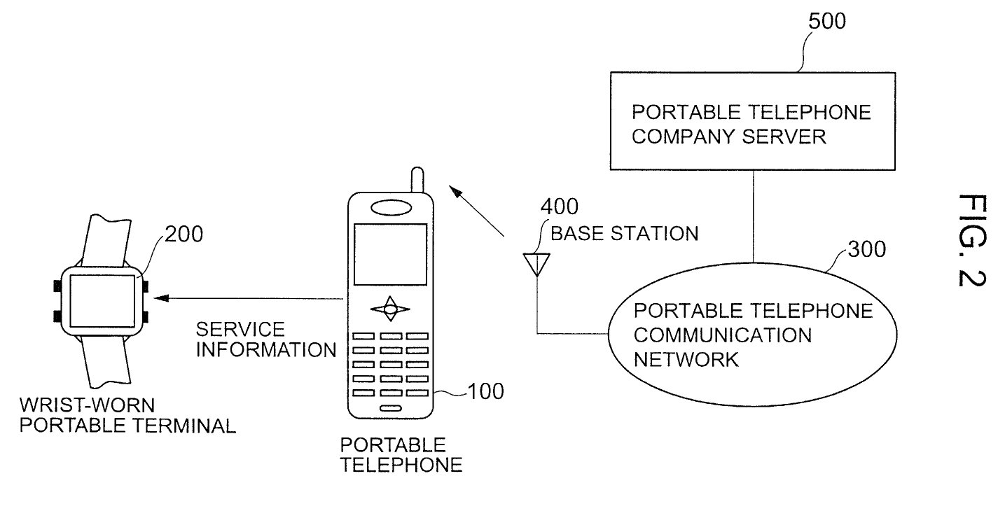

FIG. 2 is a diagram showing the network configuration of a service information provision system using a portable telephone in Embodiment 1 of the present invention. In this network system, a portable telephone 100 and a wrist-worn portable terminal 200 can transmit and receive data to and from each other by means of a small wireless device (not shown). The portable telephone 100 is connected to a portable telephone network 300 via a base station 400 to communicate with one of the other portable telephones and fixed telephones or the like (not shown). A portable telephone company server 500 is connected to the portable telephone network 300. The portable telephone company server 500 controls portable telephone communications in accordance with a communication protocol and transmits service information. The portable telephone company server 500 manages advertisements as service information, and transmits an advertisement to the wrist-worn portable terminal 200 through the portable telephone 100 to enable the wrist-worn portable terminal 200 to output the advertisement in the form of a display while the portable telephone 100 is operated for telephone conversation or the like.

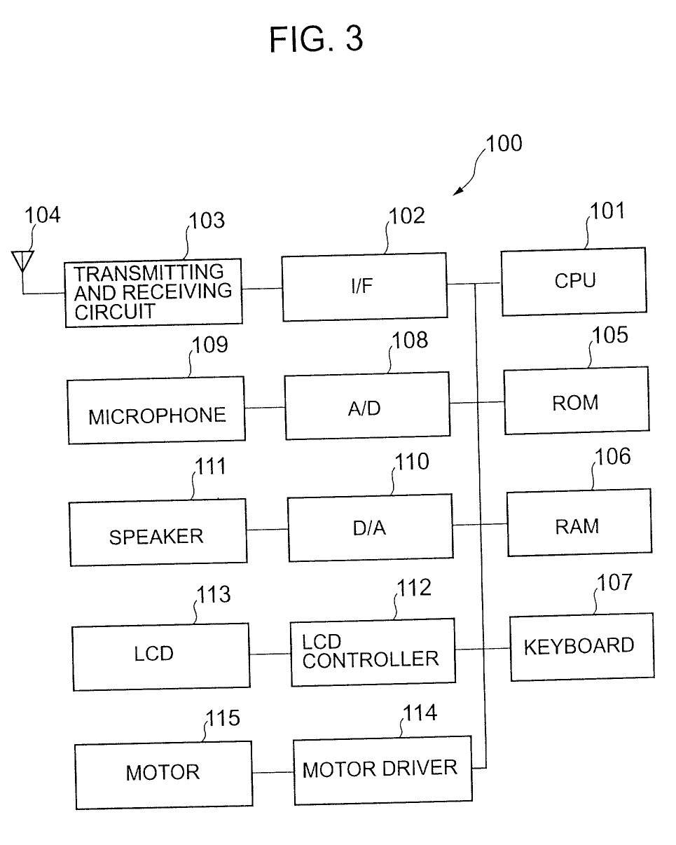

The configurations of the above-described devices and related processes will be described one by one. FIG. 3 is a diagram showing the hardware configuration of the portable telephone 100 of the present invention. The portable telephone 100 has a central processing unit (CPU) 101, an interface (I/F) 102, a transmitting and receiving circuit 103, an antenna 104, a read-only memory (ROM) 105, a random access memory (RAM) 106, a keyboard 107, an analog to digital (A/D) converter 108, a microphone 109, a digital to analog (D/A) converter 110, a speaker 111, a liquid crystal display (LCD) controller 112, a liquid crystal display 113, a motor driver 114, and a motor 115.

The CPU 101 performs overall control of the portable telephone by executing various programs. The I/F 102 is a communication interface. The transmitting and receiving circuit 103 performs processing such as conversion of the frequency of a signal at the time of transmitting or receiving. The antenna 104 receives electric waves. The ROM 105 and the RAM 106 store programs executed by the CPU 101, etc. The keyboard 107 enables a user to input a command by operating some of its keys. The A/D converter 108 converts an analog signal into a digital signal. The microphone 109 inputs speech as an analog signal. The D/A converter 110 converts a digital signal into an analog signal. The speaker 111 outputs sound. The LCD controller 112 controls the light emitting operation of the LCD 113. The LCD 113 displays various kinds of information. The motor driver 114 controls the operation of the motor 115. The motor 115 informs the user of, for example, incoming of a signal by causing vibration when operating.

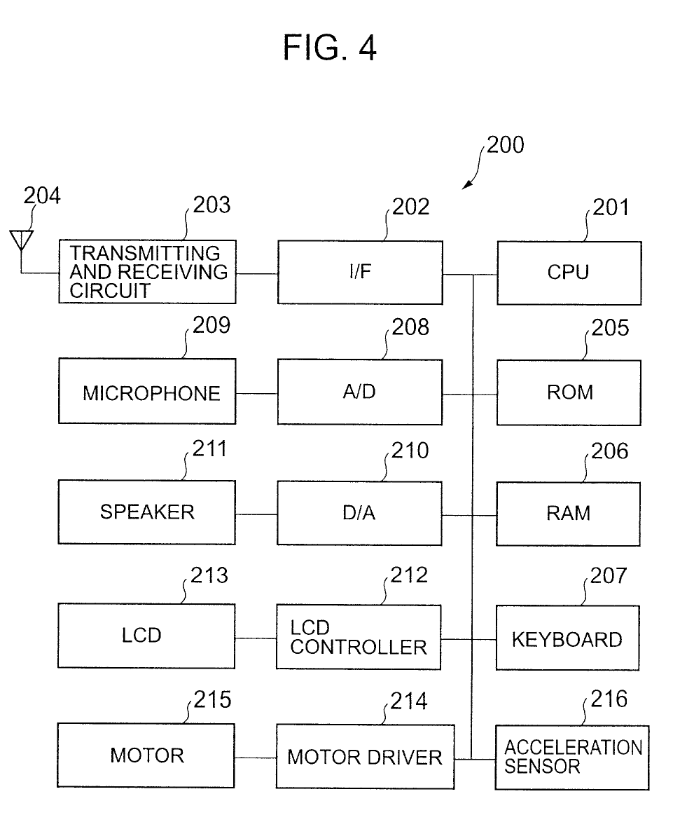

FIG. 4 is a diagram showing the hardware configuration of the wrist-worn portable terminal of the present invention. This wrist-worn portable terminal 200 has a CPU 201, an I/F 202, a transmitting and receiving circuit 203, an antenna 204, a ROM 205, a RAM 206, a keyboard 207, an A/D converter 208, a microphone 209, a D/A converter 210, a speaker 211, a LCD controller 212, a liquid crystal display 213, a motor driver 214, a motor 215, and an acceleration sensor 215.

The CPU 201 performs overall control of the portable terminal by executing various programs. The I/F 202 is a communication interface. The transmitting and receiving circuit 203 performs processing such as conversion of the frequency of a signal at the time of transmitting or receiving. The antenna 204 receives electric waves. The ROM 205 and the RAM 206 store programs executed by the CPU 201, etc. The keyboard 207 enables a user to input a command by operating some of its keys. The A/D converter 208 converts an analog signal into a digital signal. The microphone 209 inputs speech as an analog signal. The D/A converter 210 converts a digital signal into an analog signal. The speaker 211 outputs sound. The LCD controller 212 controls the light emitting operation of the LCD 213. The LCD 213 displays various kinds of information. The motor driver 214 controls the operation of the motor 215. The motor 215 informs the user of, for example, incoming of a signal by causing vibration when operating. The acceleration sensor 215 detects acceleration of the portable terminal when the user performs a predetermined confirmation operation. For example, when the user produces a rotational motion of his or her arm while the portable terminal is worn about the wrist, the acceleration sensor 215 detects an acceleration caused with the rotational motion.

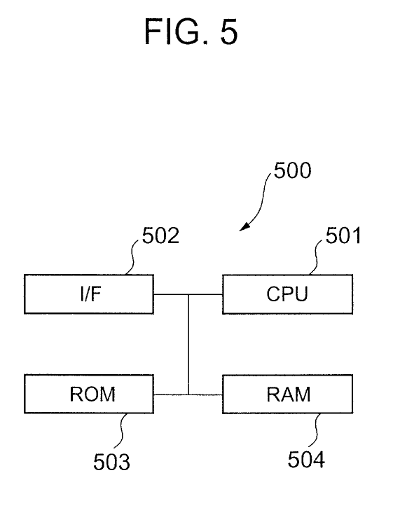

FIG. 5 is a diagram showing the hardware configuration of the portable telephone company server of the present invention. This portable telephone company server 500 has a CPU 501, an I/F 502, a ROM 203, and a RAM 504. The CPU 501 performs overall control of the server by executing various programs. The I/F 502 is a communication interface. The ROM 503 and the RAM 504 store programs executed by the CPU 501, etc. Specifically, the RAM 504 stores service information such as advertisements.

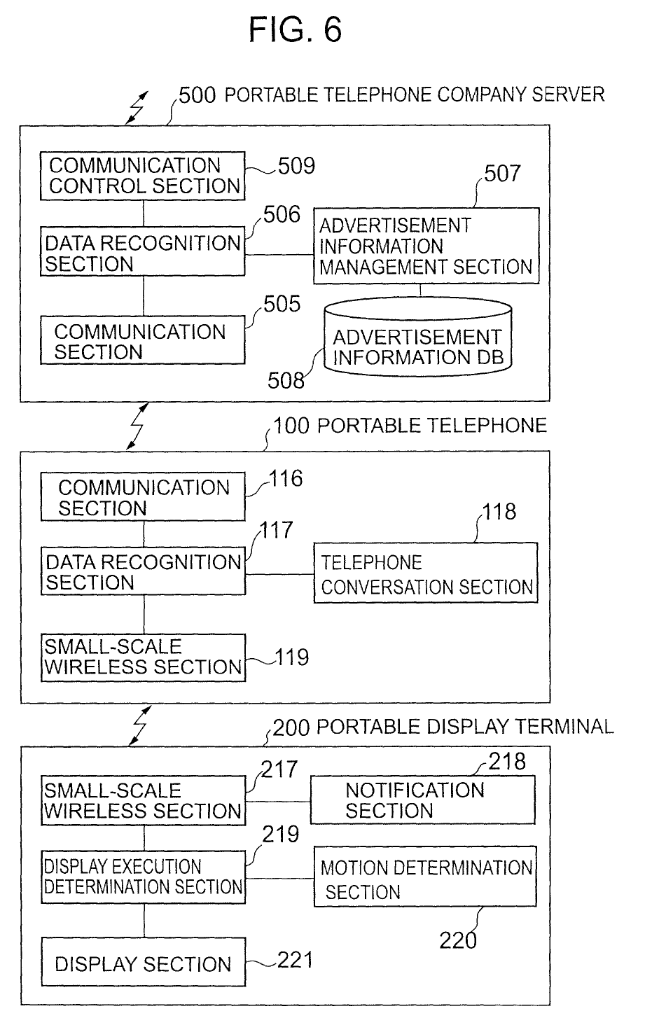

FIG. 6 is a diagram showing the configuration of functional components of the service information provision system in Embodiment 1 of the present invention. The portable telephone 100 has main sections for realizing a service information transfer function for transferring service information such as an advertisement to the wrist-worn portable terminal 200 capable of direct communication with the portable telephone 100 when the portable telephone 100 receives the service information. That is, the portable telephone 100 has, as its sections for realizing these functions, a communication section 116 for controlling communication with the portable telephone company server 500, a data recognition section 117 which makes a decision to transmit service information such as an advertisement to the wrist-worn portable terminal 200 when the service information is received during a main communication process, e.g., telephone conversation, and a small-scale wireless section 113 for controlling communication with the wrist-worn portable terminal 200. The portable telephone 100 also has a communication section 118 for controlling telephone conversation with other communication devices.

The wrist-worn portable terminal 200 has main sections for realizing a service information output function for outputting the service information when the service information is transferred from the portable telephone 100 capable of direct communication with the terminal 200, and a confirmation function for outputting the service information according to a confirmation made by the user as to whether the service information should be output, i.e., according to a result of determination that the user has performed a predetermined confirmation operation when a predetermined acceleration is detected by the acceleration sensor 215. That is, the wrist-worn portable terminal 200 has, as its sections for realizing these functions, a small-scale wireless section 217 for controlling communication with the portable telephone 100, a notification section 218 for notifying the user of incoming of service information by vibration, sound or the like, a display execution determination section 219 for making a determination as to whether service information should be displayed, a motion determination section 220 for making a determination as to whether the confirmation operation has been performed by sensing a change in acceleration caused by a rotational motion or the like of the arm, and a display section 221 for controlling display of the service information.

The portable telephone server 500 has main sections for realizing a service information transmitting function for transmitting service information to any portable telephone 100 during intervals between time periods for a main communication process performed by an arbitrary portable telephone 100, a service information accumulation function for accumulating service information to be transmitted to portable telephones 100, and a service information acquisition function for establishing a connection to a provider server (not shown) storing service information and managed by a service information provider which obtains service information from the server and transmits the service information to the portable telephone 100. The portable telephone company server 500 has, as its sections for realizing these functions, a communication section 505 for controlling communication with the portable telephone 100, a data recognition section 506 for making a decision to transmit an advertisement data to the portable telephone 100, such as when there is a request for transmission of the advertisement from the portable telephone 100, an advertisement information management section 507 for managing advertisement information, an advertisement information database (DB) 508 which accumulates advertisement information by management of the advertisement management section 507, and a communication control section 509 for controlling communication with such as an advertisement provider company server (not shown).

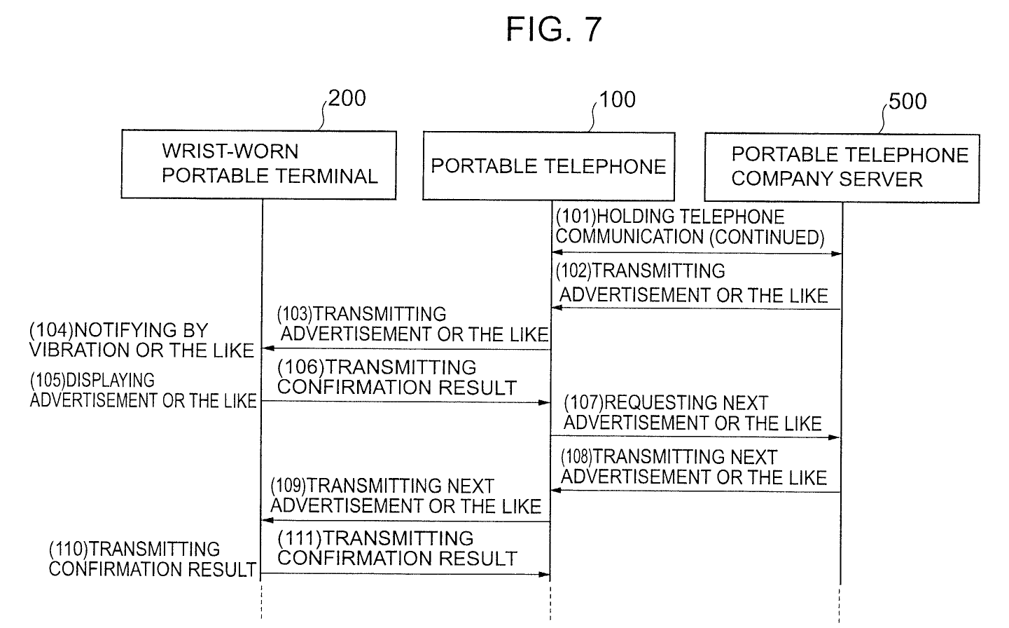

FIG. 7 is a communication sequence diagram relating to Embodiment 1 of the present invention, showing an example of transmitting and receiving among the wrist-worn portable terminal 200, the portable telephone 100 and the portable telephone company server 500. First, when the portable telephone 100 starts a telephone conversation process continuously with one of other portable telephones or fixed telephones via the portable telephone company server 500 (101), the portable telephone company server 500 transmits an advertisement or the like to the portable telephone 100 (102). Then the portable telephone 100 transfers the advertisement or the like to the wrist-worn portable terminal 200 (103). The wrist-worn portable terminal 200 notifies the user of the transfer of the advertisement or the like by means of a signal or the like (104) and displays the advertisement or the like (105). Then, when a user's confirmation operation or the like is performed, the wrist-worn portable terminal 200 transmits the result of confirmation to the portable telephone 100 (106). The portable telephone 100 then sends a request for transmission of the next advertisement or the like to the portable telephone company server 500 (107), and the portable telephone company server 500 transmits the next advertisement or the like in response to the transmission request (108).

The portable telephone 100 again transfers the advertisement or the like to the wrist-worn portable terminal 200 (109). When the confirmation operation or the like is performed, the wrist-worn portable terminal 200 displays the next advertisement or the like (110). The wrist-worn portable terminal 200 transmits the result of confirmation to the portable telephone 100(111). Subsequently, each time the advertisement information is updated, the same steps are repeated. The portable telephone company server 500 to which the confirmation result is transmitted from the wrist-worn portable terminal 200 adds a point or the like to data on the user. According to the result of addition of points, the user is privileged such as to receive a gift or to have telephone conversation with no charge.

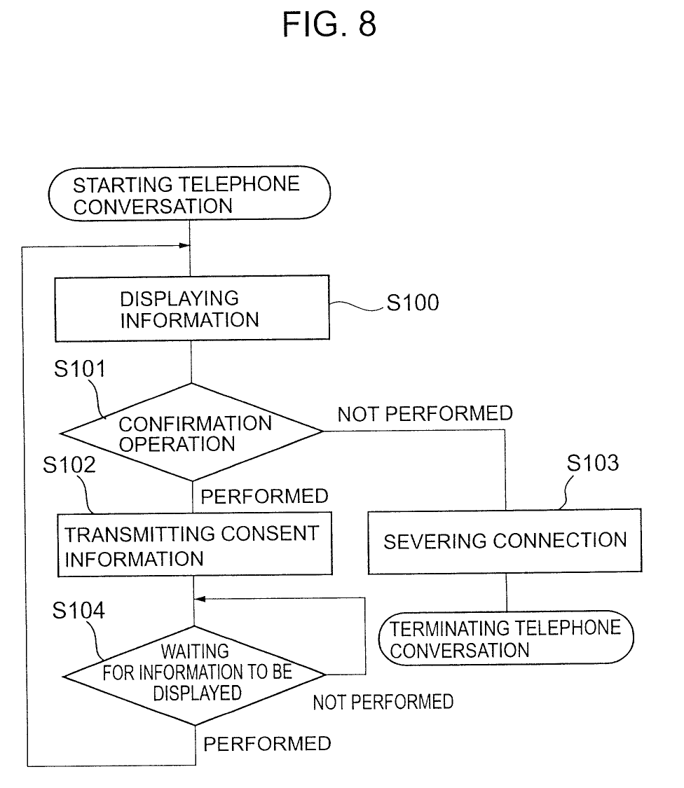

FIG. 8 is a flowchart showing a process performed by the wrist-worn portable terminal in Embodiment 1 of the present invention. In wrist-worn portable terminal 200, when an advertisement is transmitted in the course of telephone conversation, information in the advertisement is displayed (S100) and a confirmation operation is awaited (S101). When the user performs a confirmation operation (when depressing of a button or a certain motion is caused to be detected by the acceleration sensor), consent information is sent to the portable telephone company server 500 through the portable telephone 100 (S102) and information to be displayed is awaited (S104). When the next advertisement is transmitted and received, the process returns to the first step. If no confirmation operation is recognized through a predetermined time period in step S101, the connection to the advertisement information management section 507 of the portable telephone company server 500 is severed (S103) and the process is terminated when the telephone conversation is finished.

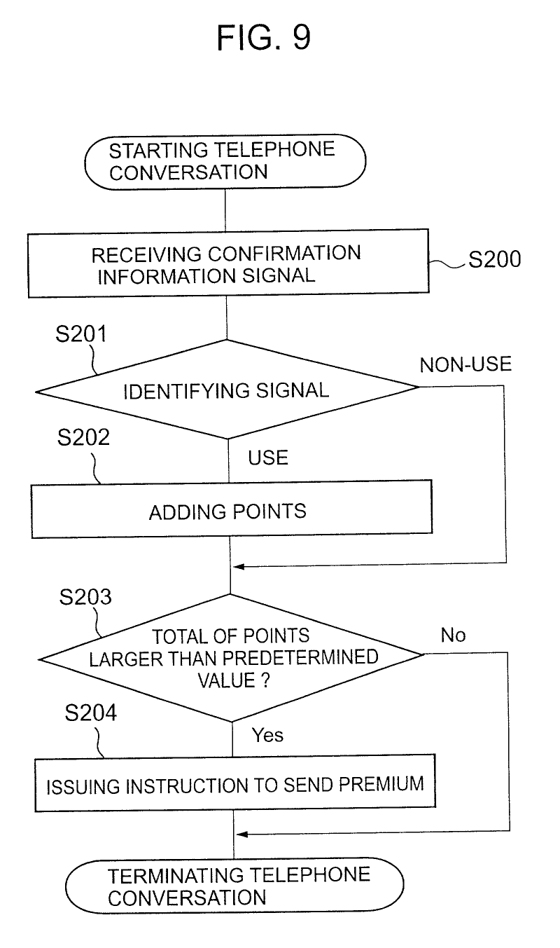

FIG. 9 is a flowchart showing confirmation operations in the portable telephone company server in Embodiment 1 of the present invention. When the portable telephone company server 500 receives a confirmation information signal transmitted from the wrist-worn portable terminal 200 through the portable telephone 100 (S200), the signal is identified (S201). If the signal is a service information use signal informing that the user is seeing the advertisement, a point is added (S202). In the case of a no-use signal indicating that the advertisement is not seen, no point is added. A determination is then made as to whether the total of points exceeds a predetermined value. If the total of points exceeds the predetermined value, for example, an instruction is issued to send a gift (S204). If the total of points does not exceed the predetermined value, the process ends immediately.

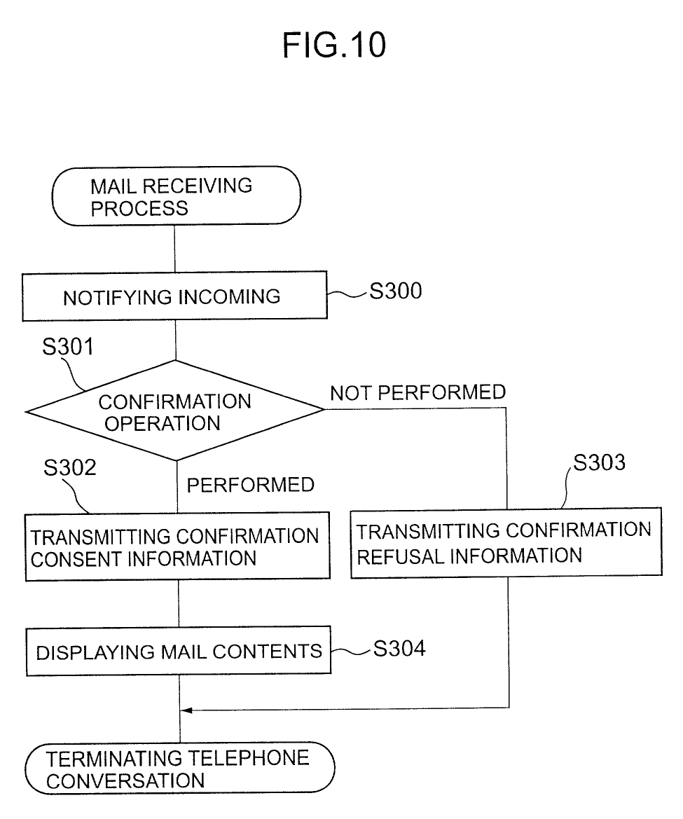

FIG. 10 is a flowchart showing another process performed by the wrist-worn portable terminal in Embodiment 1 of the present invention. In wrist-worn portable terminal 200, when an advertisement is received during mail receiving processing, information of the advertisement is output as a speech (S300) and a confirmation operation is awaited (S301). When the user performs a confirmation operation (when depressing of a button or a certain motion is caused to be detected by the acceleration sensor), consent information is sent to the portable telephone company server 500 through the portable telephone 100 (S302), the mail contents are displayed, and the next advertisement to be output as a speech is awaited (S304). When the next advertisement is transmitted and received, the process returns to the first step. If no confirmation operation is recognized through a predetermined time period in step S301, a confirmation refusal information is transmitted to the advertisement information management section 507 of the portable telephone company server 500 (S303) and the process is terminated when the telephone conversation is finished.

According to the above-described Embodiment 1, a mobile communication infrastructure can be effectively utilized to improve customer service, to provide a new business, and to offer more user-friendly communication service.

Embodiment 2

Embodiment 2 differs from Embodiment 1 in that timing of advertisement is performed by the portable telephone company server 500. Embodiment 2 will be described with respect to the points of difference from Embodiment 1, and the description for the same components and processing will not be repeated.

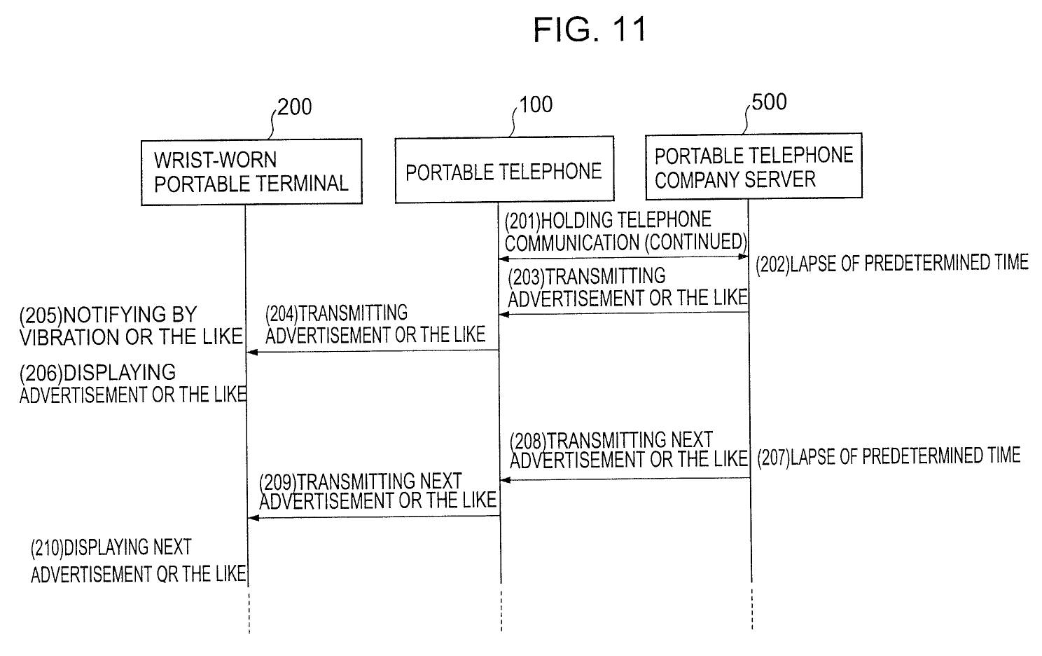

FIG. 11 is a communication sequence diagram relating to Embodiment 2 of the present invention, showing an example of transmitting and receiving among the wrist-worn portable terminal 200, the portable telephone 100 and the portable telephone company server 500. First, the portable telephone 100 starts a telephone conversation process continuously with one of other portable telephones or fixed telephones via the portable telephone server 500 (201). The portable telephone company server 500 starts measuring a lapse of time (202) and transmits an advertisement or the like to the portable telephone 100 (203). Then the portable telephone 100 transfers the advertisement or the like to the wrist-worn portable terminal 200 (204). The wrist-worn portable terminal 200 notifies the user of the transfer of the advertisement or the like by means of such as a signal (205) and displays the advertisement or the like (206).

When the portable telephone company server 500 recognizes a lapse of a predetermined time from the transmission of the first advertisement, it newly starts measuring a lapse of time (207), and transmits the next advertisement or the like to the portable telephone 100(208). Then the portable telephone 100 transfers the advertisement or the like to the wrist-worn portable terminal 200 (209). The wrist-worn portable terminal 200 notifies the user of the transfer of the advertisement or the like by means of such as a signal and displays the advertisement or the like (210). Subsequently, each time the advertisement information is updated, the same steps are repeated.

According to the above-described Embodiment 2, the user can easily obtain new service information such as advertisements without performing a confirmation operation.

Embodiment 3

Embodiment 3 differs from the above-described Embodiments 1 and 2 in that service information of such as an advertisement is accumulated on the service information provider side, and that the portable telephone company server accesses a service information provider company server of such as an advertisement to transmit service information such as an advertisement to the portable telephone side as occasion arises.

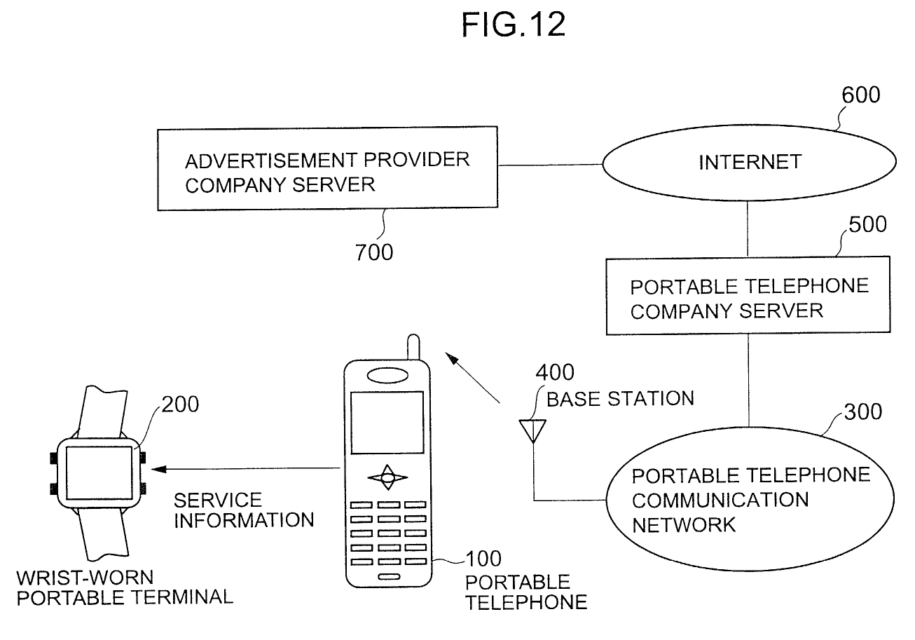

FIG. 12 is a diagram showing the network configuration of a service information provision system using a portable telephone in Embodiment 2 of the present invention. In this network system, a portable telephone 100 and a wrist-worn portable terminal 200 can transmit and receive data to and from each other by means of a small wireless device (not shown). The portable telephone 100 is connected to a portable telephone communication network 300 via a base station 400 to communicate with one of other portable telephones and fixed telephones (not shown). A portable telephone company server 500 is connected to the portable telephone communication network 300. The portable telephone company server 500 controls portable telephone communications in accordance with a communication protocol and transmits service information. The portable telephone company server 500 is connected to an advertisement provider company server 700 through the Internet 600. The advertisement provider company server 700 manages advertisements as service information, and transmits an advertisement to the wrist-worn portable terminal 200 through the portable telephone 100 according to an instruction from the portable telephone company server 500 to enable the wrist-worn portable terminal 200 to output the advertisement in the form of, such as a display while the portable telephone 100 is operated for telephone conversation or the like.

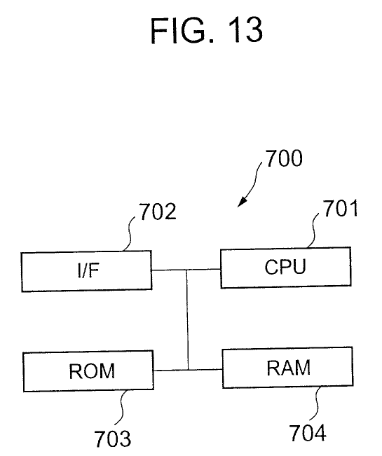

FIG. 13 is a diagram showing the hardware configuration of the advertisement provider company server of the present invention. This advertisement provider company server 700 has a CPU 701, an I/F 702, a ROM 703, and a RAM 704. The CPU 701 performs overall processing of the server by executing various programs. The I/F 702 is a communication interface. The ROM 703 and the RAM 704 store programs or the like executed by the CPU 701. Specifically, the RAM 704 stores service information such as advertisements.

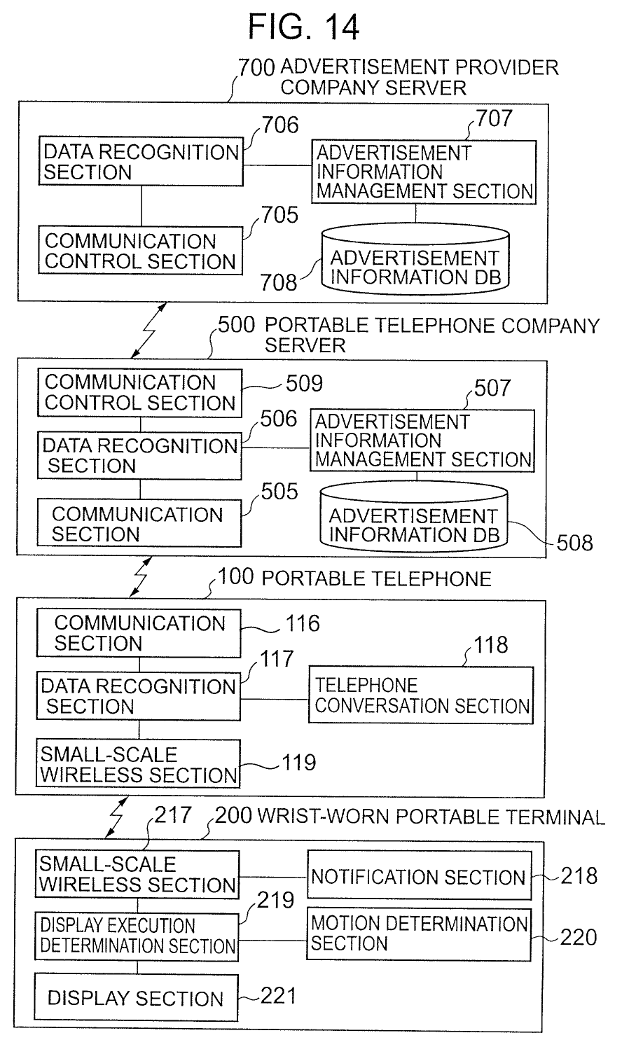

FIG. 14 is a diagram showing the configuration of functional components of the service information provision system in Embodiment 3 of the present invention. The configuration of functional components of each of the portable telephone 100, the wrist-worn portable terminal 200 and portable telephone company server 500 is the same as that in Embodiment 1, and the description for it will not be repeated. However, the communication control section 509 of the portable telephone company server 500 controls communication with the advertisement provider company server 700 or the like.

The advertisement provider company server 700 has main sections for realizing a function for enabling the portable telephone company server to access the server on the service information provider side, in which service information such as advertisements is accumulated, to transmit service information such as an advertisement to the portable telephone side as occasion arises. That is, the advertisement provider company server 700 has, as its sections for realizing this function, a communication control section 705 for controlling communication with the portable telephone company server 500, a data recognition section 706 which makes a decision to transmit advertisement data through the portable telephone company server 500 when, such as a request for transmission of an advertisement is sent from the portable telephone 100, an advertisement information management section 707 for managing advertisement information, and an advertisement information database (DB) 708 for accumulating advertisement information under the management of the advertisement information management section 707.

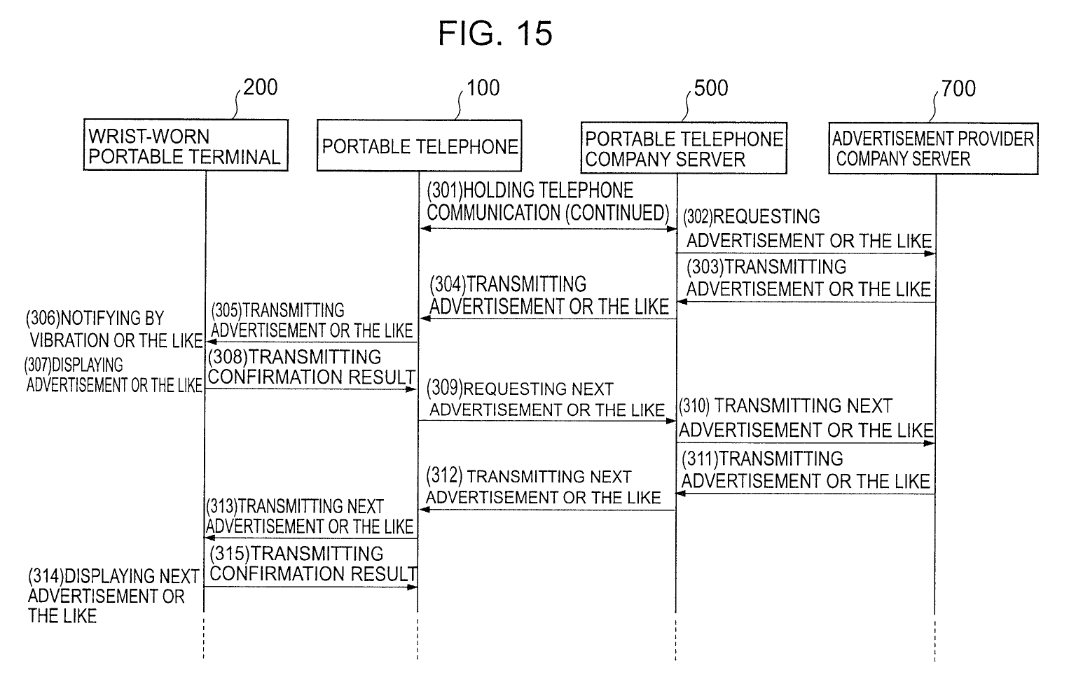

FIG. 15 is a communication sequence diagram relating to Embodiment 3 of the present invention, showing an example of transmitting and receiving among the wrist-worn portable terminal 200 the portable telephone 100, the portable telephone company server 500, and the advertisement provider company server 700. First, the portable telephone 100 starts a telephone conversation process continuously with one of other portable telephones or fixed telephones via the portable telephone server 500 (301). During this process, the portable telephone company server 500 sends a request for transmission of an advertisement or the like to the advertisement provider company server 700 (302), and the advertisement provider company server 500 transmits an advertisement or the like to the portable telephone company server 500 in response to the transmission request (303). Then the portable telephone company server 500 transmits the advertisement or the like to the portable telephone 100 (304). The portable telephone 100 transfers the advertisement or the like to the wrist-worn portable terminal 200 (305).

The wrist-worn portable terminal 200 notifies the user of the transfer of the advertisement or the like by means of such as a signal (306) and displays the advertisement or the like (307). When a user's confirmation operation or the like is performed, the wrist-worn portable terminal 200 transmits the result of confirmation to the portable telephone 100 (308). The portable telephone 100 then sends a request for transmission of the next advertisement or the like to the portable telephone company server 500 (309), and the portable telephone company server 500 sends a request for transmission of the next advertisement or the like to the advertisement provider company server 700 (310). The advertisement provider company server 500 transmits the next advertisement or the like in response to the transmission request(311). Then the portable telephone company server 500 transmits the advertisement or the like to the portable telephone 100 (312), and the portable telephone 100 transfers the advertisement or the like to the wrist-worn portable terminal 200 (313). When the confirmation operation or the like is performed, the wrist-worn portable terminal 200 displays the next advertisement or the like (314), and transmits the result of confirmation to the portable telephone 100 (315). Subsequently, each time the advertisement information is updated, the same steps are repeated.

The portable telephone company server 500 to which the confirmation result has been transmitted from the wrist-worn portable terminal 200 adds a point or the like to data on the user, as in Embodiment 1. According to the result of addition of points, the user is privileged such as to receive a gift or to have telephone conversation with no charge.

In Embodiment 3 described above, it is not necessary for the portable telephone company server 500 to accumulate advertise information, so that the resources at the portable telephone company server 500 can be effectively utilized.

In a case where the service information is such as a quiz or a questionnaire, it is not necessary for the user to answer it during a telephone conversation. Quiz or questionnaire data may be temporarily stored in a memory and the user may answer it (input an answer) after the telephone conversation. A reply to such service information may be manually transmitted each time. However, it is not necessary to immediately transmit the reply. For example, the reply may be stored in a memory and transmitted at the time of the next telephone conversation.

Advertisements may be transmitted periodically at several times in one day, for example, such as in the morning, at midday and in the evening as well as during telephone conversation. If the amount of data of service information such as an advertisement is large, it may be displayed by being scrolled. Further, the timing of switching of an advertisement or the like may have, for example, a cycle of 30 seconds. If a confirmation operation is performed within a certain time period (e.g., within 10 seconds) after receiving each advertisement, the charge for a length of telephone conversation before or after it is reduced to zero (or discounted, or a point is added).

At the time of confirmation with respect to a speech advertisement, the user may be asked to answer a quiz corresponding to the contents of the speech advertisement such that it is possible to ascertain from the answer whether the user has listened to the advertisement. The effectiveness of an advertisement can be improved by this method. The charge for telephone conversation may be reduced to zero if the answer is correct, and the user may be required to pay the charge if the answer is incorrect. Also, at the time of acquisition of a pay content (road traffic jam information or a weather forecast), the user may obtain the content with no charge if the user answers a questionnaire or sees an advertisement.

According to the present invention, as described above, a mobile communication infrastructure is effectively utilized to improve customer service, to provide a new business, and to offer a more user-friendly communication service.

What is claimed is:

1. A method of providing service information through a mobile communication device, comprising the steps of:
accumulating service information to be transmitted to mobile communication devices;
transmitting service information to an arbitrary mobile communication device during intervals between time periods for a main communication process performed by the arbitrary mobile communication device; and
outputting the service information on the mobile communication device side.

2. A method of providing service information according to claim 1, further comprising the step of transferring the service information from the mobile communication device receiving the service information to a portable terminal capable of direct communication with the mobile communication device, wherein the portable terminal outputs the service information.

3. A method of providing service information according to claim 1, further comprising the step of requesting a user to confirm the user's intention to output the service information or not.

4. A method of providing service information according to claim 2, further comprising the steps of:
requesting a user to confirm the user's intention to output the service information or not; and
outputting the service information by determining that the user has performed a predetermined confirmation operation when an acceleration sensor provided in the portable terminal detects a predetermined acceleration.

5. A method of providing service information according to claim 1, further comprising the step of transmitting the service information to the mobile communication terminal and making the mobile communication terminal output the service information in a predetermined cycle during the main communication process.

6. A method of providing service information according to claim 1, further comprising the step of computing an amount claimed to be paid for communication such that the charge for communication to be paid by the user using the service information during the main communication process is reduced to zero while the service information provider is charged the amount corresponding to the charge for communication.

7. A method of providing service information according to claim 1, further comprising the step of computing an amount claimed to be paid for communication such that the charge for communication to be paid by the user using the service information during the main communication process is discounted, while the service information provider is charged the amount corresponding to the reduction in the charge for communication to be paid by the user.

8. A method of providing service information according to claim 1, further comprising the step of adding a point for offering a privilege to the user according to the service information used by the user during the main communication process.

9. A method of providing service information according to claim 1, further comprising the step of transmitting the service information as letter or image information to the mobile communication device and making the mobile communication device display the information if the main communication process is a process of telephone communication using speech.

10. A method of providing service information according to claim 1, further comprising the step of transmitting the service information as speech information to the mobile communication device and making the mobile communication device announce the information if the main communication process is a process of communication using letters or an image.

11. A system for providing service information through a mobile communication device, comprising:
service information accumulation means for accumulating service information to be transmitted to the mobile communication devices;
service information transmitting means f or transmitting service information to an arbitrary mobile communication devices during intervals between time periods for a main communication process performed by the arbitrary mobile communication device; and
service information outputting means for outputting the service information on the mobile communication device side.

12. A system for providing service information through a mobile communication device according to claim 11, further comprising service information transfer means for transferring the service information from the mobile communication device receiving the service information to a portable terminal capable of direct communication with the mobile communication device, wherein the service information transfer means is provided in the portable terminal, and the portable terminal outputs the service information.

13. A system of providing service information according to claim 11, further comprising confirmation means for requesting a user to confirm the user's intention to output the service information or not.

14. A system of providing service information according to claim 12, further comprising:
confirmation means for requesting a user to confirm the user's intention to output the service information or not; and
an acceleration sensor provided in the portable terminal,
wherein, when a predetermined acceleration is detected by the acceleration sensor, the confirmation means determines that the user has performed a predetermined confirmation operation, and enables outputting of the service information.

15. A system of providing service information according to claim 11, further comprising timing output means for transmitting the service information to the mobile communication terminal and making the mobile communication terminal output the service information in a predetermined cycle during the main communication process.

16. A system of providing service information according to claim 11, further comprising free-of-charge communication fee computation means for computing an amount claimed to be paid for communication such that the charge for communication to be paid by the user using the service information during the main communication process is reduced to zero while the service information provider is charged the amount corresponding to the charge for communication.

17. A system of providing service information according to claim 11, further comprising discounted communication fee computation means for computing an amount claimed to be paid for communication such that the charge for communication to be paid by the user using the service information during the main communication process is discounted, while the service information provider is charged the amount corresponding to the reduction in the charge for communication to be paid by the user.

18. A system of providing service information according to claim 11, further comprising point addition means for adding a point for offering a privilege to the user according to the service information used by the user during the main communication process.

19. A system of providing service information according to claim 11, further comprising letter and image selection means for transmitting the service information as letter or image information to the mobile communication device and making the mobile communication device display the information if the main communication process is a process of telephone communication using speech.

20. A system of providing service information according to claim 11, further comprising announcement selecting means for transmitting the service information as speech information to the mobile communication device and making the mobile communication device announce the information if the main communication process is a process of communication using letters or an image.

21. A mobile communication device comprising service information transfer means for transferring service information to a portable terminal capable of direct communication with the mobile communication device when the mobile communication device receives the service information.

22. A portable terminal comprising service information output means for outputting service information when the service information is transferred from a mobile communication device capable of direct communication with the portable terminal.

23. A portable terminal according to claim 22, further comprising means for requesting a user to confirm the user's intention to output the service information or not.

24. A portable terminal according to claim 23, further comprising an acceleration sensor, wherein when a predetermined acceleration is detected by the acceleration sensor, the confirmation means determines that the user has performed a predetermined confirmation operation, and enables outputting of the service information.

25. A mobile communication management server comprising service information transmitting means for transmitting service information to an arbitrary mobile communication device during intervals between time periods for a main communication process performed by the arbitrary mobile communication device.

26. A mobile communication management server according to claim 25, further comprising service information accumulation means for accumulating service information to be transmitted to the mobile communication devices.

27. A mobile communication management server according to claim 25, further comprising service information acquisition means connected to a provider server which manages a service information provider, in which service information to be transmitted to the mobile communication devices is accumulated, the service information acquisition means for obtaining service information from the server and for transmitting the service information to the mobile communication device.

28. A computer-readable recording medium comprising a program stored thereon, the program enabling a computer to execute a method of providing service information through a mobile communication device according to claim 1.

29. A computer-readable recording medium comprising a program recorded thereon so as to be readable by a computer, the program realizing the respective means according to claim 11.
